(19) United States
(12) Patent Application Publication
(10) Pub. No.: US 2021/0271864 A1
(43) Pub. Date: Sep. 2, 2021

(54) APPLYING MULTI-CHANNEL COMMUNICATION METRICS AND SEMANTIC ANALYSIS TO HUMAN INTERACTION DATA EXTRACTION

(71) Applicant: Beyond Expression LLC, Chicago, IL (US)

(72) Inventor: Victoria Litvin, Chicago, IL (US)

(21) Appl. No.: 17/187,873

(22) Filed: Feb. 28, 2021

Related U.S. Application Data
(60) Provisional application No. 62/983,317, filed on Feb. 28, 2020.

(51) Int. Cl. G06K 9/00

(52) U.S. Cl. CPC G06K 9/00335

(57) ABSTRACT

A method and system for in-depth person interaction analysis and data extraction, applicable to digitally captured social communication and/or human—machine interaction. The method can include: capturing media data over multiple channels (video, audio, spatial, health, etc.); capturing interaction's related artifacts (e.g., presentation slides, screen capture); enriching the collected data with data from non-interaction data sources (e.g. social media); extracting communication metrics from the captured media data; building a comprehensive sentiment perception product that is a time-based derivative of sentiment expressions based at least in part on a combination of the communication metrics; providing communication analysis result that is based at least in part on the sentiment perception product; enriching communication analysis result by cross-mapping sentiment perception product to semantically meaningful time segments of an interaction identified by analyzing media data and interaction's artifacts.

### CROSS-REFERENCE TO RELATED APPLICATIONS

This Application claims the benefit of U.S. Provisional Application No. 62/983,317 filed on 28 Feb. 2020, which is incorporated in its entirety by this reference.

### TECHNICAL FIELD

This invention relates generally to the field of digitally captured interactions and more specifically to a new and useful system and method for human interaction analysis.

### BACKGROUND

Human interaction, particularly communication, is an essential part of our day-to-day lives. Nonverbal Communication (NVC) is a reflection of signals with non-verbal means such as facial expressions, gestures, body language, gaze, paralanguage etc. NVC can be important for understanding the real semantics of a particular interaction that, for example, cannot be derived from the interaction's transcript (e.g., using NLP analysis of the transcript).

NVC is often an important part of the communication between two or more parties. However, at times, real-time communication might be overwhelming, and participants might miss important NVC signals. In some cases, NVC signals may be contextual and might be caused by the words, NVC of another person, or environment. As one example, with more global communication happening over digital communication tools, the personal background of one participant may affect how one participant projects and interprets NVC communication differently of other participants.

There are ever increasing occurrences of human interactions that involve video/audio conferencing or a video/audio/3d capturing device (e.g. an external camera, or Augmented Reality (AR) glasses, Virtual Reality (VR) headset). While such technologies have simplified aspects of communication, such as enabling higher quality video communication and group conferencing, the new forms of communication, globalization, and faster pace of communication can also reduce our ability to properly project and receive NVC, for example. There are few available technical tools that help people in improving their communication effectiveness.

Thus, there is a need in the field of technology facilitated communication to create a new and useful system and method for interaction analysis that aids users in comprehending and handling non-verbal contexts of an interaction. This invention provides such a new and useful system and method.

### BRIEF DESCRIPTION OF THE FIGURES

FIGS. 1-3 are flowchart representations of variations of the method.

FIG. 4 is a schematic representation of an exemplary sentiment perception vector.

FIG. 5 is a schematic representation of translating media data into a sentiment perception product.

FIGS. 6-10 are schematic representations of variations of analyzing communication metrics.

FIGS. 11-12 are schematic representations of variations that include mapping sentiment expressions to interaction fragments.

FIG. 13 is a schematic representation of one exemplary implementation.

FIG. 14 is a schematic representation of an exemplary set of communication metrics.

FIG. 15 is a detailed schematic representation of a variation of base sentiment expressions derived from communication metrics.

FIG. 16A-16D are exemplary representations of data processing stages potentially involved in building a sentiment perception.

FIG. 17 is an exemplary schematic representation of segmenting interaction fragments.

FIG. 18 is a schematic representation of mapping sentiment expressions to interaction fragments.

FIG. 19 is an exemplary representation of user interfaces with various types of communication analysis feedback.

FIG. 20 is a schematic representation of a first system.

FIG. 21 is a schematic of an example system implementation.

FIG. 22 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for human interaction analysis can enable a digital tool that monitors and analyzes language and behavior of participants, along multiple communication dimensions, so as to provide communication insights. This may be used to potentially improve the effectiveness of a subject participant in an interaction with one or more other target participants. In particular, the system and method can facilitate identifying sentiment-based insights for a person interaction, including, but not limited to spoken communication and/or visual communication.

The system and method may be used in augmenting and modifying digitally captured interactions that include person-to-person communication (e.g., N-person interactions including dialogues and monologues) and/or of human-machine interactions (HMIs). In one example, the system and method may be used within digital communications involving audio or video conversations between two or more humans. In another example, the system and method may be used within communications involving one or more humans interacting with a machine/digital service. In another example, the system and method may be used with a digital tool in augmenting real-life interactions (e.g., through use of a digital tool like an augmented reality headset).

In one variation, the system and method can include: collecting media data from active participants during a digital interaction; extracting communication metrics from the media data; analyzing the communication metrics with respect to the effectiveness of the subject participant during the interaction; and providing communication analysis results. The communication analysis can include extracting interaction fragments from the media data based, at least in part on processed communication metrics. The communication analysis may additionally or alternatively include providing subject feedback with regard to the interaction.

In one preferred variation of the system and method, an omnichannel sentiment perception product is generated and used. In such a variation, the system and method may include collecting media data from active participants during a digital interaction; extracting communication metrics (e.g., verbal and non-verbal communication cues of the participants) and/or other communication content of an interaction (e.g., a transcript or interaction artifacts); processing the communication metrics and optionally supplementary communication content, building a sentiment perception product based on a combination of processed communication metrics; segmenting the interaction into interaction fragments according to content relevant signals; and then mapping sentiment to interaction fragments according to the sentiment perception product.

The system and method function to leverage multiple metrics of human behavior and response, employing forms of communication analysis, such as enhanced facial analysis (e.g., facial landscape analysis, facial expression recognition/classification, etc.), vocal analysis, natural language processing (NLP), machine learning, and/or other suitable analysis techniques to analyze and provide metric based insights into expressions of various sentiments during an interaction. The system and method may be used to generate various forms of results such as a perception heat map and/or extracted interaction fragments. Dependent on implementation, these context specific recommendations may be provided in real-time, post-interaction, or at some other desired time interval.

The system and method may apply sentiment analysis across one or more different communication channels. For example, sentiment analysis may be applied with interactions that include or capture an interaction transcript, paralanguage, facial expressions, body language, additional sensor data (e.g. biometric data like pulse), digital data (e.g., presentation or application state), and/or other forms of data related to communication of one or more participants.

The system and method may be used where the communication metrics are processed into a time-based data representation of sentiment expressions that are evident or perceived to be presented by one or more participants during the interaction. In one preferred variation, the communication metrics can be converted into a sentiment perception product characterizing occurrences of different sentiment expressions using various approaches as discussed herein. The sentiment perception product may be used to label, identify, or extract the sentiment-important fragments or time ranges of an interactions that may be invaluable for: enabling a participant to comprehend NVC occurred during the interaction and identify NVC associated context; helping/training an individual to comprehend how other persons might perceive the interaction; and/or other applications. In some cases, the sentiment perception product of the system and method may enable a digital tool providing high utility for a person with less social conciseness (e.g. lower nonverbal sensitivity) or Empathy Deficit Disorder (EDD).

In one variation, the sentiment perception product can be a time-based data model or characterization of sentiment expressions which is a data derivative based at least in part on a combination of communication metrics. This may be a holistic analysis of verbal and non-verbal communication metrics. The sentiment perception product may be used in mapping sentiments to interaction fragments. In one such variation, interactions can be split into fragments with high semantic cohesion. In one exemplary variation, this can include identifying points in time or windows in time of a transcript with high grammar and/or lexical cohesion. In another exemplary variation, this may include identifying other selections of an interaction-related digital data (e.g., identifying a particular slide of a presentation shared during a conversation).

In another variation, the sentiment perception product may additionally or alternatively be used in identifying and marking various interaction fragments corresponding to detected sentiments and/or other analysis of media data of the interaction. For example, this may be used in selecting and identifying sections of a conversation with the highest positive sentiment, most negative sentiment, most impactful content, or other analysis results.

As an additional or alternative variation, the sentiment perception product may also be used in building/generating a sentiment perception heat-map of the identified fragments. A sentiment perception heat map can be a data-based representation of digital interactions that can be used to reflect the state of the interaction visually in real-time or in a post-interaction report. The sentiment perception heat map may additionally or alternatively be used as a data source. As a data source, the sentiment perception heat map can be accessible over an application programming interface, exposed within a Platform as a Service (PaaS) platform. The sentiment perception heat map may additionally or alternatively be used to provide interaction guidance and/or build an analytics system.

The system and method may be adapted for various specific applications.

In one variation, the system and method can be used in providing feedback, information, or other forms of analysis on an interaction. This use case may primarily involve interactions with two or more participants, but as described may also include HMI.

In one variation, the system and method can be used to enabling extracting and/or highlighting of different segments of an interaction based on sentiment. For example, semantically significant portions of a conversation between two participants may be identified, highlighted, and/or characterized (e.g., labeled). In one implementation, a perception heat map can be generated to identify and mark interaction fragments corresponding to detected sentiments. Additional or alternative forms of feedback may also be generated. Such feedback can be incorporated into specific digital tools to assist in various use cases.

In some exemplary use cases, the system and method may be implemented as a specific social interaction aid (e.g. customer service aid implemented in an office communication system). As a customer service assistant, a digital communication tool leveraging the system and method may enable customer service agents to better assess the feelings, attitudes, priorities, sensitive points, of a customer and respond accordingly. The system and method could be integrated into a video or audio conference call application so that real-time feedback can be provided during a call or provided as a post call summary. When used by individuals presenting content, the effectiveness of the presentation can be measured and presented as real-time guidance. For example, a presenter's spoken words, screen sharing content, content of a slide presentation, the speakers facial and body language, and the audience responses may all be measured and used in generating a communication analysis and recommendations. The system and method may alternatively be implemented and applied for any suitable use case.

In a sales-related use case, the system and method may also be implemented as an enterprise level sales tool/aid. The system and method may be integrated into the communication tools used by work representatives (e.g. sales agent, customer service agent, hiring agent, interrogator, etc.) to aid the representative in the “sales”-type interaction. The representative may interact with a customer over a video call, wherein the representative may be aided by the system and method. In this implementation, the system and method may help provide the representative with possible actions (e.g., questions to ask), and through monitoring of the customer, provide feedback to the representative on the reaction of the customer. The system and method may additionally be used within an analytics system that interprets and reports on patterns/results of multiple interactions.

As a presenter tool related use case, the system and method may be implemented as a social media aid (e.g. for use by a social media influence). An influencer may implement the system and method to better assess viewer/consumer perception regarding posts made by the influencer, wherein the viewer/consumer perception may be assessed at any particular point in time in the post, presentation topic (e.g., perception for material related to a brand in an influencer's “unpacking” video of multiple brands), and/or during other interaction fragments. In particular, the system and method may be used during live streams so that the communication cues of the influencer and/or the responses of the viewing audience can be analyzed and used to delivering real-time feedback.

In another use case, the system and method may be utilized to provide user experience analysis and feedback for a user interface. That is, the system and method may be implemented as part of analysis software on some platform (e.g. website), wherein the external cues of the user are monitored during interaction with the platform. Such a platform may enable analysis of the user interaction with a targeted software (e.g. web-application or mobile application) to reveal usability weak points. The system and method may thus enable the platform to utilize a non-verbal channel to gather user experience feedback in addition to verbal feedback and an interface interaction video recording.

The system and method can additionally be adapted and used within different forms of digital experiences. A primary example used herein is a digital application, which may be presented through a computing device such as a smart phone, tablet, or a computer. The system and method may alternatively be used in other computing user interface mediums such as within an AR user interface, a VR user interface, and/or an audio interface as examples. In an AR/VR application, the method may be incorporated into a portable and wearable system (e.g. smart phone or smart glasses). In this implementation, the system and method may provide real-time feedback to the subject participant during a participant interaction. This can be adapted to provide feedback during in-person and/or virtual meetings. A person may receive sentiment heat map built from data from the capturing device. In one example, this can enable the system and method to be used to output communication analysis results when talking to a live person. In another example, the system and method can be used to provide a presenter with a sentiment heat map based on audience reactions/sentiments (using media and/or sensor data captured by an AR device).

In another use case variation, the system and method may be implemented as an application facilitating guided interaction that at least partially drives digital interactions based on analysis outputs of the system and/or method. Use of the system and method for a guided interaction may be used for single participants (e.g., within a training or “simulation” application for job interview training, job training, and/or other interaction simulations) or multiple participants (e.g., guided social interactions like within a social and/or dating application). A guided interaction application can be offered through a variety of types of devices such as a smart phone, computer, AR/VR device, smart audio device, or other interactive devices.

A training application may be for any desired type of social interaction. Examples of preferred implementations include: speech trainer, interview trainer, date trainer, and conversation trainer. As a training application, the method may simulate target participants, whereby during the participant interaction between the subject participant and target participant(s), the method may analyze and provide feedback regarding the effectiveness of the subject participant.

In an exemplary interview training application, a subject may interact with a simulated interviewer implemented through a computer-implemented device (e.g. computer monitor, phone) and presented via a screen, audio, or other suitable interface, wherein the interviewer preferably interviews the subject participant. As the interview progresses, the method may analyze the expressed sentiments of a subject and provide real-time and/or a report feedback with respect to the effectiveness of the subject participant. As part of analyzing the external cues, in some variations the simulated interviewer may simulate external cues to additionally provide stimulation to the participant and promote the training of the participant during a guided interaction for the subject participant. For example, simulated interviewer may frown if the subject participant responses are unsatisfactory. Additionally, the simulated interviewer may use the communication measurements and/or external data sources (e.g., LinkedIn or other social media data sources) to alter the questions or prompts.

In an exemplary speech training application, the system and/or method may provide multiple simulated target participants that may respond to the subject participant. Alternatively, in some implementations there are no target participants, and the subject participant may give a presentation/practice-talk in the presence of one or more capture devices (e.g., a camera or audio recording device). The method may then analyze and provide general feedback from just the external cues of the subject participant.

In an exemplary guided interaction application involving multiple participants, the system and method may supply participants with questions, challenges, and/or other digital prompts within a user interface of an application. The analysis output (e.g., a sentiment heat map) for communication of one or more participants as generated by the system and method can be supplied to one or more of the participants. This can be used with dating applications, various social application, or other types of applications.

The system and method may provide a number of potential benefits. The system and method are not limited to always providing such benefits, and are presented only as exemplary representations for how the system and method may be put to use. The list of benefits is not intended to be exhaustive and other benefits may additionally or alternatively exist.

As one potential benefit, the system and method may be used for identifying sentiment-significant fragments, segments, or other portions of digital interactions. Such fragmenting can be based on analysis of multiple sources of media data and different forms of communication including both verbal and non-verbal communication.

As another potential benefit, the system and method may enable communication feedback to be generated through a specialized computer-implemented system so that a user can understand the impact of their communication. Such feedback may be used to better enable a communicator to improve their communication. In particular, there may be benefits in informing and/or training individuals on how others perceived an interaction. In some cases, the system and method may enable a digital tool providing high utility for a person with less social conciseness (e.g. lower nonverbal sensitivity) or Empathy Deficit Disorder (EDD).

As another potential benefit, the system and method may measure multiple communication signals, which may make the measure more comprehensive. The system and method can measure signals for speaker, audience members and/or other conversation participants such as body language (e.g., facial expressions, pose estimation), speech qualities (e.g., tone of speech), speech content (e.g., subject of words/statements, sentiment of words/statements), supplementary communication mediums (e.g., slide presentation or screen sharing content analysis and/or visual analysis).

As another potential benefit, the system and method may enable real-time feedback while communicating. The system and method may be implemented such that analysis and the state of their communication style can be indicated as a substantially real-time signal. Other implementations may provide such analysis after communication ended as a post-analysis of the communication session.

As another potential benefit, the system and method may enable a person to adjust current communication flow. That is, the system and method may enable the person to identify important topics, through real-time feedback, and help guide the conversation to these specific topics in the future.

As another potential benefit, the system and method may perform interaction analysis for various participant communication “topologies”, that is to say, for various ways in which sources of sentiment expressions relate to the sources of communicated content. For example, the system and method can apply the interaction analysis to interpret: how one's own sentiment perception relates to the communicated content of that participant, how one or more participants responds to the communication of a second participant, and/or how other collections of participants respond. In some instances, the system and method may be used to produce sentiment perception products of different participants in one interaction to independently understand sentiment expressions for multiple participants.

As another potential benefit, the system and method may be applied to understand a set of interactions. Analysis can be performed across multiple interactions to identify, report on, or perform various actions in response to the high level analysis of multiple interactions.

### 2. Method

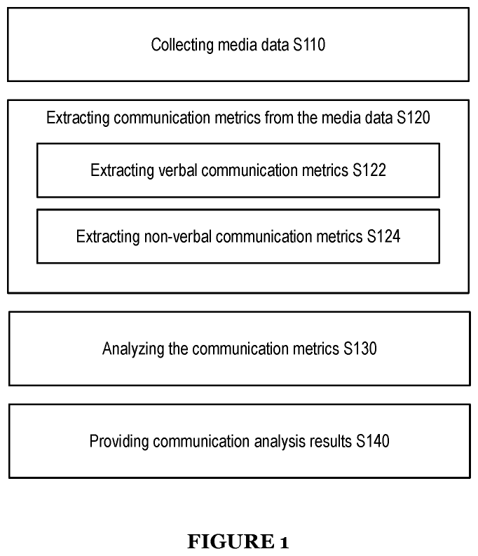

A method for interaction analysis can used for identifying sentiment-based insights for a person interaction. This may include, but is not limited to, spoken communication (e.g., dialogic, multiparty, or monologue interactions) and/or HMI (e.g., interactions with mobile applications, web applications, and the like). As shown in FIG. 1, a method for interaction analysis may include: collecting media data S110; extracting communication metrics from the media data S120; analyzing the communication metrics S130; and providing communication analysis results S140. Extracting communication metrics from the media data can include extracting verbal communication metrics S122 and extracting non-verbal communication metrics S124.

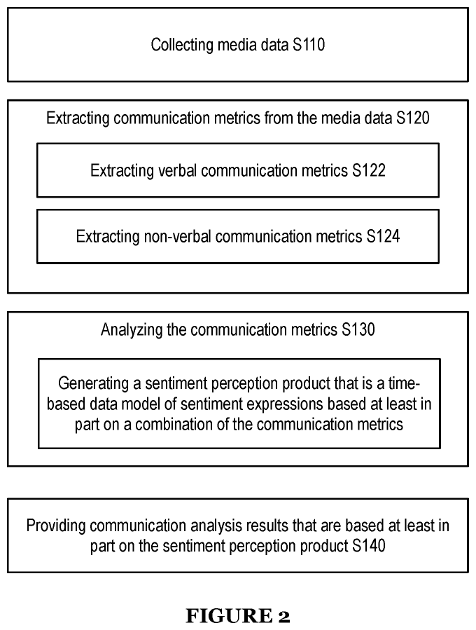

As shown in FIG. 2, one variation of the method may include: at a digital media system, collecting media data of an interaction S110; at a media analysis engine, extracting communication metrics from the media data S120, which may comprises extracting at least one type of verbal communication metric (S122) and/or at least one type of non-verbal communication metric (S124); analyzing the communication metrics S130 and generating a sentiment perception product that is a time-based data derivative of sentiment expressions based at least in part on a combination of the communication metrics; and providing communication analysis results S140 that are based at least in part on the sentiment perception product.

The method functions to gather, analyze, and leverage data from the interaction, to provide a contextual sentiment-based analysis of an interaction preferably using multiple “channels” of communication. The analysis may be provided through real-time feedback and/or in post interaction feedback. This can be used to offer sentiment-based insights for person interactions.

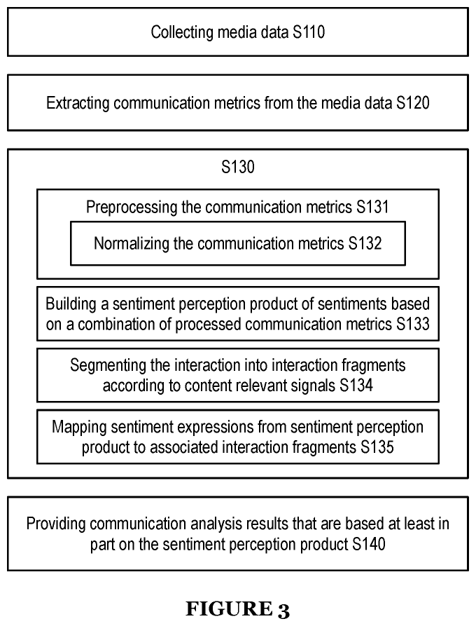

In some variations, the analysis of communication metrics is used to form a time-based data analysis product of various sentiment expressions, which may then be used to map sentiment expressions to corresponding segments of the interaction (i.e., interaction fragments). This can be used, in some variations, in mapping sentiment expressions to meaningful time/interaction ranges (e.g., not just the direct time occurrence of the sentiment expression). As shown in FIG. 3, such a variation of the method for interaction analysis may more specifically include collecting media data during a digital interaction S110; extracting communication metrics (e.g., verbal and non-verbal communication cues of the participants) S120; preprocessing the communication metrics S131 (e.g., normalizing the communication metrics S132), building a sentiment perception product based on a combination of processed communication metrics S133; segmenting the interaction into interaction fragments according to content relevant signals S134; mapping sentiment expressions from sentiment perception product to associated interaction fragments S135, and providing communication analysis results S140.

Herein, interaction is used to characterize digitally facilitated and/or captured communication involving at least one participant. Dependent on implementation, the participant interaction may comprise an interaction of a subject participant alone (e.g. a practice interview), a subject participant with a single target participant (e.g. a conversation), or a subject participant with multiple targets participants (e.g. a meeting, a speech, social media post). The interaction may include one or more main “presenters”. However, the method may additionally or alternatively be used in conversations where there is no central presenter.

More generally, an interaction may comprise any type of interaction captured by a digital computing device where at least one participant (i.e. a subject participant) performs an action (e.g. talking, waving, smiling) that may be interpreted by a hypothetical or real observer(s) (i.e. target participant(s)). Examples of interactions with hypothetical target participants may include: practice talks, practice interviews, pre-recorded messages, pre-recorded video (e.g. social media posts), video stream, live stream, or any other interactions with target participants who may not directly respond to the interaction. Examples of interactions with real target participants include: conversations, speeches, dates, meetings, interviews, presentations, performances, a live stream, or any other interaction wherein the target participants may directly, or indirectly, respond in the interaction. It should be noted that the scope of target participant(s) response is in no way limited and may even include no response.

As used in this context, the terms “subject” and “target” are used to convey perspective for analysis without attaching any additional properties to either term, unless explicitly stated otherwise. That is, the method is implemented with regards to the subject participant (e.g. to improve the communication effectiveness of the subject participant) with respect to target participant(s) in an interaction. In some variations, the method may be implemented simultaneously for multiple subject participants. For example, in a meeting with multiple participants, the method may be implemented for each participant, such that the “each participant” is the subject participant for a set of analyses and all other participants are target participants. For example, for an interaction comprising two people on a romantic date, the method may be implemented for each person, such that each person on the date is the subject participant for their implementation, and the other participant is the target participant.

As used herein, media data may be used to refer to any collectable data in reference to the interaction to be analyzed. Media may be analog or digital, but in many variations will be digitized through processes of the method for analysis. Media data in many variations may include video data and/or audio data. The media data may generally include any type of data that may be quantified for analysis, e.g. collected by digital media systems and analyzed by media analysis system. Examples of media data beyond video and audio data may include sensor data (e.g. from a smart watch, medical device), transcript data if available, interaction associated time-based artifacts (e.g. a presentation slide a computer UI, a captured screenshare (which may be video data)), and/or other suitable types of interaction related media data. In some cases, media data may additionally include other forms of sensor data such as biometric data (E.g., heart rate, respiratory rate, perspiration level, and the like) or kinematic data (e.g., accelerometer data).

In some variations, the method may be implemented multiple times simultaneously for a single subject participant and different target participant(s). For example, for an interaction that is a televised speech given by the subject participant, the interaction may be analyzed with respect to the target participants attending the speech, target participants viewing the speech on television, and target participants comprising both groups. In another example, a social media influencer (e.g. a video blogger) subject participant may post a video that may then be analyzed with respect to target participants once they view the post.

The method may be used to provide analysis for any general social interaction, which may be in real-time or posterior (e.g., after the interaction). In this manner, the method may be implemented as part of an augmented reality experience (e.g., eyeglasses with camera), virtual reality experience (e.g. with VR glasses), as part of a virtual interaction (e.g. virtual interview), a video chat/conference and/or as an educational teaching/coaching tool (e.g. as an application on a computing device). For example, the method may be implemented to provide analysis and feedback for a real-time social conversation, a virtual interview, a virtual speech environment, or a sales training conversation.

Additionally, the method may be used to provide improved user experience analysis and feedback. As part of user experience analysis software, the method may utilize the user interaction with targeted software (e.g. web-application or mobile application) to reveal usability weak points and/or optimize user flows. The method may enable the software platform to utilize non-verbal channels to gather user experience feedback in addition to verbal feedback and an interface interaction video recording. The use of non-verbal channels, for example, may enable improved analysis by mapping assessed sentiments to particular UI interaction elements and/or user flows (e.g. dialogs, controls).

The method may be implemented with the system as described herein. Additionally, the method may be implemented with any Turing complete processing device (preferably with sufficient analysis and data storage capability and specially enabled with machine-readable instructions for implementation of configured processed described herein) and optionally one or more capture/sensing devices. Exemplary capture and/or sensing devices may include a visual recording device (e.g., a camera), audio recording device, spatial imaging device (e.g., Lidar, depth camera), biometric sensors, and/or other suitable types of devices for capturing media or otherwise sensing data related to an interaction. The method may thus be implemented as a smart phone or computer application, web-based application, as a cloud executed method with multimedia accessibility, and/or any other system with sufficient capability.

Block S110, which includes collecting media data, functions to acquire and/or capture media data involved in an interaction. The collected media data will generally include media data that can be used in assessing verbal and non-verbal forms of communication. In some variations, collecting media data S110 occurs at, or through, a digital media system. Collecting media data S110 may include acquiring multiple forms of media data, such as acquiring video and/or audio data. More broadly, collecting media data can include collecting and/or capturing data from at least one of the following data channels: audio data, video data, sensor data, biologically based data, spatial data (e.g., 3D data, depth map data, and the like), and/or interaction-associated media data. Biologically based data may include biometric data collected and/or sensed from one or more participants. Such biometric data can include pulse, respiratory rate, oxygen levels, perspiration levels, brain activity and the like. The interaction-associated media data can include time-based digital artifacts from the interaction such as presentation digital files, computer interface data, application state meta data, and the like.

In some cases, collecting media data S110 can include collecting media data from multiple participants, multiple locations, and/or multiple sources. For example, video and/or audio can be collected from each participant. In another example, multiple camera perspectives of one or multiple participants may be collected and used. Collecting media data may additionally include acquiring interaction associated time-based artifacts, which may serve as supplemental data related to an interaction. These digital interaction artifacts can include exemplary media data content such as video transcripts or closed captions, video notes or chats, shared multimedia files, captured screenshares, presentation slides demonstrated during the interaction, and/or other supplementary media data.

Video data, image data, and/or audio data will generally be collected from a video, image, or audio recording device. Alternatively, such media data may be received through a digital communication. Other forms of media data such as interaction-associated media data may be collected by monitoring and/or extracting data from an application, browser session, or other computing environment.

In some instances, the method may additionally include collecting other types of data, which could indirectly relate to an interaction and/or relate to a participant. This external data, in some variations, may be used for analysis of the communication metrics, analysis of the media data (e.g., for segmenting), and/or for guiding various digital interactions. Examples of such external data could include social media data (e.g. social media profile, comments, posts, and content), historical data (e.g. medical history, work history, workout history), data files related to the interaction, and/or any other applicable type of user related data.

In some variations collecting the media data S110 may include splitting the media data. Splitting the media data functions to parse the media data for extraction. Splitting the media data may be implementation specific. One or more media data sources may be split or otherwise separated and associated with relevant participants. In one example, audio data may be split and/or labeled according to participant was an active speaker at a particular moment. In another example, video data may be split in order to extract relevant facial video of specific participants. This separated media data can be used for extracting communication metrics in process S120.

The method preferably applies processes of extracting communication metrics S120 and analysis of the communication metrics S130 in order to transform the media data into some form of communication analysis. Herein, one final or intermediary result of this data transformation may be referred to as a sentiment perception product. A sentiment perception product can be characterized as a time-based data characterization of sentiment perception. The sentiment perception product can be a derivative of multiple communication metrics and, in some variations, other interaction related content like a transcript or interaction artifacts.

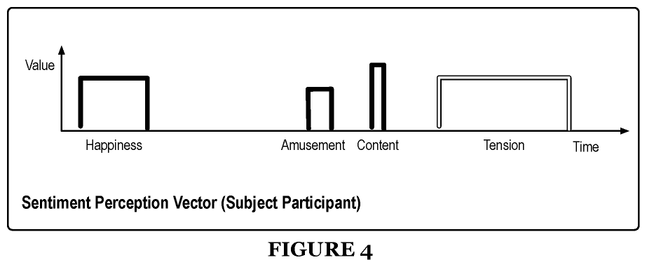

In some variations, the sentiment perception product may more specifically be a sentiment perception vector as shown in FIG. 4. A sentiment perception vector is one possible result of the analysis of the communication metrics. As a vector, different classifications of sentiment expressions (and optionally their value/strength) may be associated with time windows. The sentiment perception vector may include a set of diverse sentiments such as anger, excitement, amusement, fear, disgust, content, awe, sadness, surprise, contempt, embarrassment, happiness, fake happiness, tension, nervousness, sarcasm, uncertainty, doubt, attention, and/or other sentiment classifications. The sentiment perception vector may alternatively use a set of sentiment expressions of a different nature. For example, another alternative variation may use only sentiment expressions of positive and negative to indicate favorable reactions or unfavorable reactions.

In some variations, this sentiment perception product may further be used in mapping sentiment expressions to interaction fragments (e.g., portions of the media data or related interaction data that have been segmented independent from a semantic/contextual based approach).

As detailed below, there may be various approaches to perform such processing, and the variations described herein, as can be appreciated by those skilled in the art, does not limit the method to such variations.

Block S120, which includes extracting communication metrics, functions to transform the media data into an initial interpretation of “interaction cues” signaled during communication. In some variations, extracting communication metrics S120 may occur through a media analysis engine. As used herein, communication metrics refer to measures and/or characterizations of verbal and/or non-verbal interaction cues: actions (or lack of actions), which may potentially provide information regarding participant communication. The communication metrics may be used in building the sentiment perception product.

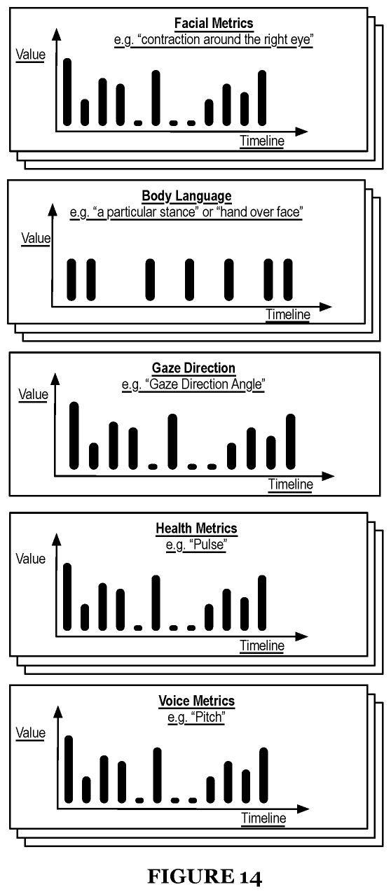

Extracting communication metrics S120 may thus comprise extracting verbal communication metrics S122 and/or extracting non-verbal communication metrics S124. As shown in FIG. 14, this may involve extracting a set of various different types of communication metrics. The communication metrics generally relate to various signals or factors that relate to the interaction and the communication of a participant. Examples of extracted communication metrics can include a transcript, body pose features, facial features, voice metrics, natural language processing (NLP) analysis of verbal content (e.g., via analysis of a transcript), interaction artifacts (e.g., presentations, screenshares), environmental data, biometric/activity data of one or more participants, and/or other types of communication metrics.

Verbal communication metrics (or verbal cues) may comprise language content. In addition to language content, verbal cues may include: filler words (e.g. words repeated by a participant), verbal mumblings, changes in language pacing, changes in word selection, punctuation utilization, language phrasing, etc. Extracting verbal communication metrics S122 may include applying natural language processing (NLP), or other techniques, to determine the language content of the media data. In some variations, extracting speech based verbal cues may be also include converting speech to text.

As non-verbal communication metrics may cover a much broader range of communication metrics, extracting non-verbal communication metrics S124 may be “communication metric” specific. Examples of non-verbal communication metrics may include: facial feature movements (e.g. eye positioning, mouth positioning, cheek positioning), head movement, body pose features (e.g. movement of arm, leg, hand, elbow, shower, head, neck, and/or posture), health metrics (e.g. pulse, breathing rate), voice metrics (e.g. pitch), social media cues (e.g. real-time “liking”/emoting, real-time changes in rates of commenting/posting). In some variations, modeling the communication metrics (e.g. through neural networks or other machine learning models) may be implemented to appropriately identify, classify, and/or other interpret non-verbal communication metrics.

As an example, a set of communication metrics could include metrics related to facial features, body pose features, eye/gaze, voice, text, and/or health metrics. Other suitable combinations of features may be used.

Extracting a transcript may include processing audio data of one or more participants and generating a text transcript of the interaction. The transcript may be segmented and broken down by participant, but, alternatively, the transcript may be a direct speech-to-text translation. In one implementation, the transcript may be generated directly using suitable machine learning speech-to-text applied to audio data. In another implementation, the transcript may be retrieved by submitting the audio in a transcription request to a transcription service and receiving a transcript in response.

Additionally or alternatively, text/transcript related metrics could be extracted. In one implementation, text/transcript related metrics could include identifying, classifying, or otherwise characterizing fillers, repetition, and/or sentence length.

Extracting body pose features may involve processing of video data, image data, spatial data, and/or kinematic data of a user for interpreting and/or classifying body pose features. In one variation, particular gestures or actions may be classified (and possibly associated with different sentiment characterizations). Examples of body pose features can include: body gestures (e.g. hand wave), posture (e.g. slouching, head orientation, etc.), direction or characterization of attention (e.g., eye contact/looking away), and the like.

Extracting facial expressions may similarly involve processing video data, image data, spatial data, and/or kinematic data of a user for interpreting and/or classifying facial expressions. Extracting facial expressions can include analyzing general facial feature metrics (e.g. mouth expression, eye expression, gaze direction) in addition to employing facial recognition/expression software. Using facial expression analysis model, digital points along the face landscape may be identified and monitored for metrics with respect to analyzing facial cues. For example, direction of attention of a participant may be measured and used in analyzing direction of attention, changes in attention, patterns in attention, and/or other aspects.

In the case where collected media data includes two or more participants, body language and/or facial expressions (and other forms of non-verbal) communication may be extracted for each identified (and tracked) participant.

Extracting voice metrics may involve interpretation and characterization of the manner in which a participant speaks. This may include characterizing pitch, pace, speech traits (e.g. stutters, repeated phrases, frequency of filler words), clarity of speech, volume of speech, and/or other characterizations of speech. Related to voice metrics, extracting communication metrics may also include characterization of audio, which can include other forms of audio analysis such as classifying crowd reactions (e.g., identifying crowd sounds like laughter, applause, amazement, fright, anger, etc.). In one implementation, extracting voice metrics could include classifying or characterizing pitch, volume, articulation/clarity, pace, and/or pause.

Extracting health metrics functions to use biometric related sensing data to determine health-related state of a participant. In one implementation, health related metrics could include identifying, classifying, or otherwise characterizing pulse, respiration, perspiration, and/or brain activity.

Extracting NLP insights of communication media can be applied to interpretation of spoken words via the transcript. Extracting NLP insights of communication media may also be applied to interpretation of visual communicated text such as the text presented in a slide. In one implementation, sentiment analysis can be applied to the communication media to identify a time-based map of sentiment. This can be used to identify emotionally highlighted content.

Extracting interaction artifacts can be used in establishing a record of how interaction-related media (e.g., digital media) is used and relates to an interaction. Such interaction artifacts may include documents, images, web pages, graphics, captured screenshares, or UIs, or other interaction related digital media. In the case of an application or website, meta data about the state of such a digital experience may be recorded. In general, extracting interaction artifacts establishes a time-based map of the state of interaction artifacts used during an interaction. Extracting interaction artifacts may additionally include identifying, extracting, and/or generating interpretations of text, audio files, image files, video files, charts, and/or other types of media within the digital media. Extracting interaction artifacts may additionally or alternatively track when certain user actions are performed (e.g., when a slide is changed, or some button is clicked). Related to extracting interaction artifacts, extracting meta data of a digital interaction may include recording or tracking digital actions. This may be used for tracking social interactions such as real-time likes, “emotes”, comments, shares, and/or other social signals.

Block S130, which includes analyzing communication metrics, functions to analyze and evaluate the interaction of at least one participant. As mentioned, analyzing the communication metrics can be used in generating a sentiment perception product. A sentiment perception product can be a time-based data representation of sentiment expressions that is derived based at least in part on a combination of communication metrics. In some implementations, the sentiment perception product is a holistic and consolidated representation of all sentiments expressed through different communication “channels”.

The sentiment perception product preferably relates different sentiment expressions (made by one or more participants) to a time interval of an interaction. The sentiment perception product can be stored and be accessible from a computing system for processing and usage. For example the sentiment perception product may be stored in memory (e.g., in a non-transitory computer readable medium), within a database system. The sentiment perception product may be a singular data record or file. The sentiment perception product may alternatively be represented through a collection of related data records which may be stored in different or shared computer memory and/or databases. The data structure of the sentiment perception product could vary depending on implementation. For example, the sentiment perception product could be a vector, a multidimensional array, a collection of different sentiment expression value timelines, and/or other suitable forms.

In one preferred implementation, the sentiment perception product may be implemented as a sentiment perception vector, which serves as a time-based data representation of dominant sentiment expression from one or more participants. The sentiment perception vector can function to consolidate representation sentiment expressions. The sentiment perception vector can be a timeline of different sentiment expression classification values as shown in FIG. 4. In one preferred variation of the sentiment perception vector, sentiment expressions are represented by their identity (the type of sentiment), optionally a value of the sentiment (e.g., intensity of the sentiment), and a time property (e.g., time range or instance).

The sentiment perception product may be a final output result used in providing communication analysis results in S140. Alternatively, a sentiment perception product may be produced and used as an intermediary result or product of analyzing communication metrics. In one preferred variation, the time-based data model of the sentiment perception product is used to map determined instances of sentiment expressions to select segments of the interaction. The output of the analysis can be used in providing communication analysis results in S140.

In general, analyzing communication metrics S130 can include processing and assessing multiple types of communication metrics, creating a consistent and holistic model of sentiments expressed within the communication metrics (e.g., modeled within the sentiment perception product), and relating assessment of the communication metrics to the interaction. Analyzing communication metrics S130 may occur through a media analysis system. Analyzing communication metrics S130 may include analyzing the communication metrics of the subject participant, analyzing the communication metrics of target participants in response to the subject participant, and/or analyzing the communication metrics of some and/or all participants.

Analyzing communication metrics S130 may include analyzing verbal and/or non-verbal communication metrics. The analysis preferably functions to form a combined analysis of multiple types of communication metrics. In other words, interpretation of an interaction can be used based on interpretation of multiple communication channels. Those channels may include verbal communication metrics and/or non-verbal communication metrics.

The method may be implemented using various approaches to translating communication metrics into a sentiment perception product and/or other analysis result(s).

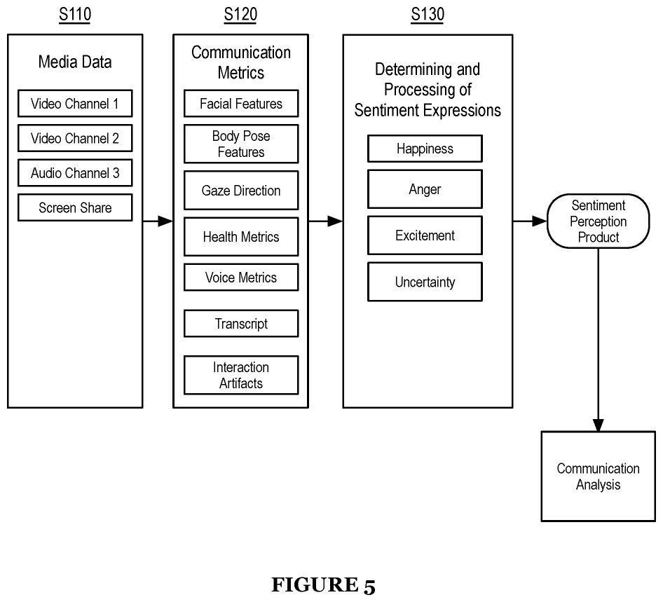

A processing pipeline is used to translate communication metrics into the sentiment perception product (e.g., a sentiment perception vector). The processing pipeline can vary depending on implementation but generally identifies base sentiment expressions from the communication metrics and then optionally refines the base sentiment expressions into a sentiment perception product. As shown in the exemplary FIG. 5, a set of communication metrics may be used in determining data characterizations of happiness, anger, excitement, and uncertainty (though any suitable set of sentiment expressions could be used). These data characterizations of various sentiment expressions are then used in outputting a sentiment perception product.

The processing pipeline used in analyzing the communication media may include sub-processes such as various data processing processes (e.g., applying decision trees, using a machine learning model, etc.), normalizing, calibrating (e.g., calibrating for cultural or background processing), consolidating (e.g., performing sentiment vector building), and/or other forms of pre-processing, intermediary processing, and/or post processing. As another possible variation, some sentiment expressions may be extracted directly from media data. For example, audio may be translated directly into voice or general sentiment expressions, an interaction artifact like a visual presentation could be translated directly into sentiment.

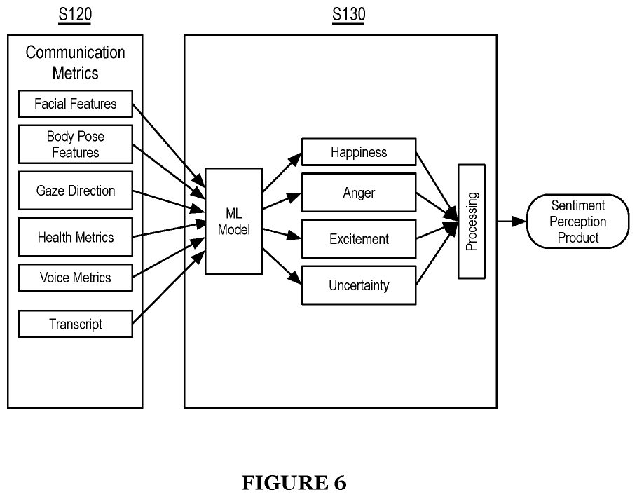

In one exemplary analysis variation, as shown in FIG. 6, analyzing the communication metrics may include initially applying a machine learning model (or other processing model) to identify base sentiment expressions and processing the base sentiment expressions to obtain a sentiment perception product (e.g., a sentiment perception vector). A base sentiment expression could be a time-based data representation of one particular sentiment expression. It will generally be used as an intermediary data representation used to form the sentiment perception product. In the example of FIG. 6, base sentiment expressions for happiness, anger, excitement, uncertainty are shown but any suitable combination of sentiment expressions could be used. In this variation, the base sentiment expressions are an assessment of sentiment across multiple communication metric “channels” thereby consolidating expressed sentiments from different ways of expressing sentiment. In some instances use of machine learning models or other techniques for identifying sentiments may additionally normalize sentiment values. However, a normalization process may alternatively be performed before and/or after sentiment identification.

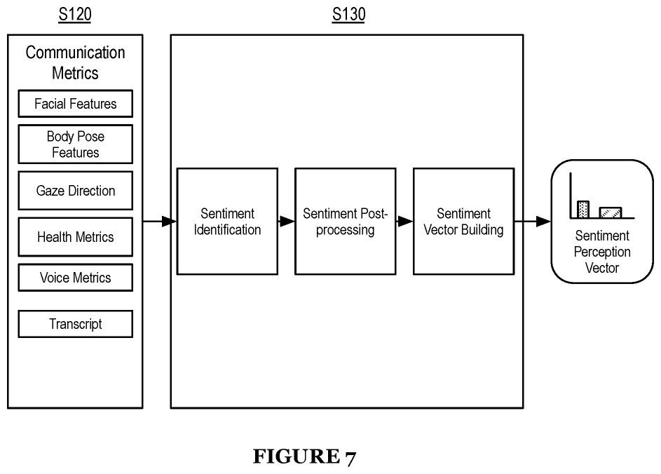

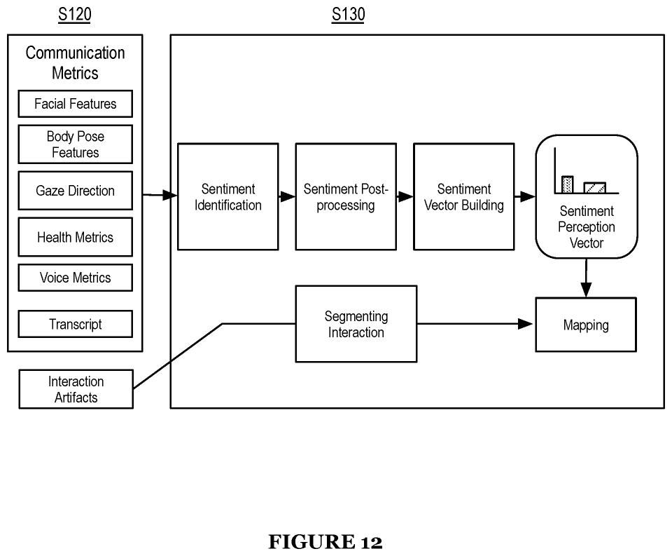

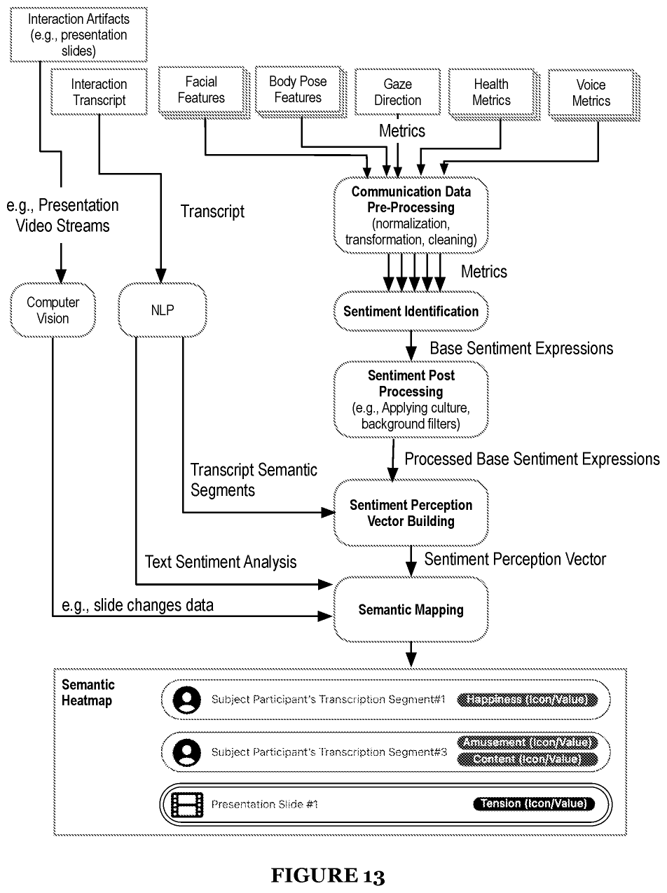

In another exemplary analysis variation, the variation of FIG. 6, may be more specifically applied to a process that includes performing sentiment identification (using machine learning, decision trees, or other sentiment identification processes), optionally applying post processing (e.g., normalizing, applying cultural or background filters) to refine a set of base sentiment expressions, and the building a sentiment perception vector from the set of base sentiment expressions as shown in FIG. 7. This variation is applied within the variations shown in FIG. 12 and FIG. 13 described herein.

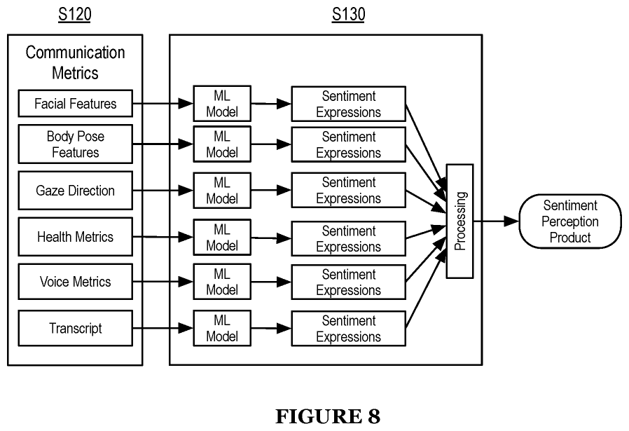

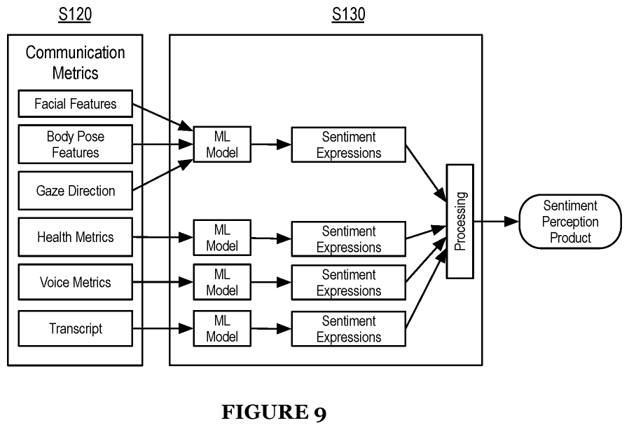

In another exemplary analysis variation, analyzing the communication metrics may include more parallel processing of communication metrics to assess sentiment. As shown in FIG. 8, multiple communication metrics may be processed in parallel (e.g., using a machine learning model (shown) or other suitable approach) to determine distinct sets of base sentiment expressions. For example, there may be base sentiment expression data for happiness, anger, and excitement as derived from each communication metric. As shown in FIG. 8, the different sets of base sentiment expressions may be condensed through some processing technique to form the sentiment perception product. In some variations, a hybrid approach may use multiple communication metrics to determine one set of base sentiment expressions while other communication metrics may be individually processed to determine distinct sets of base sentiment expressions as shown in FIG. 9.

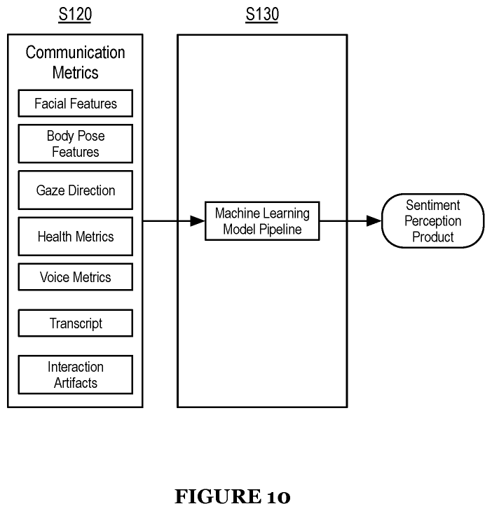

In another exemplary analysis variation, analyzing the communication metrics may use a machine learning model (or an alternative algorithmic model) to translate communication metrics directly into the sentiment perception product as shown in FIG. 10. This exemplary variation also shows how a transcript and/or interaction artifacts (e.g., presentation slides) may also be used to derive sentiment.

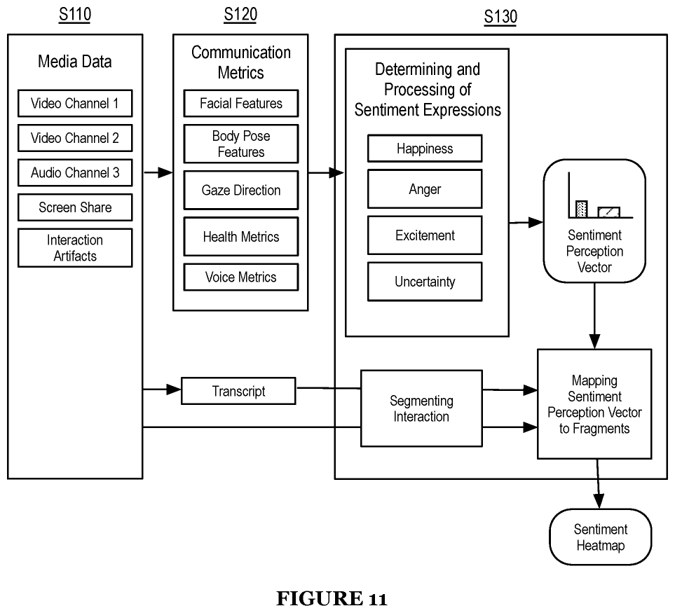

Additionally, in some preferred variations, analyzing communication metrics may include or otherwise be used for mapping sentiments to interaction fragments. As shown in FIG. 11, various media data (or resulting interpretations like a transcript) can be used in segmenting an interaction and then using the sentiment perception product (e.g., using the sentiment perception vector as shown) to map sentiments to related interaction fragments. This may result in a sentiment heatmap as shown in FIG. 11, but could alternatively be used for extracting interaction segments of interest based on sentiments, indexing interaction segments by sentiment, and/or for other purposes. As shown in FIG. 12, the analysis processing pipeline variations discussed above for determining the sentiment perception product may be used with the mapping variation. Also shown in FIG. 12, the method is not limited to always using the same sets of communication metrics or media data for determining sentiments and/or for the mapping. In this example, interaction artifacts, like presentation slides, may be the content that is segmented.

In one preferred variation, analyzing communication metrics is applied to relate various sentiment insights to particular portions of an interaction, such a variation can include preprocessing the communication metrics S131 (e.g., normalizing the communication metrics S132), building a sentiment perception product based on a combination of processed communication metrics S133; segmenting the interaction into interaction fragments according to content relevant signals S134; mapping sentiment expressions from sentiment perception product to associated interaction fragments S135 as shown in FIG. 3. The techniques described herein in relation to the processes of S131, S132, S133, S134, and S135, such as processes of normalizing, filtering, building a sentiment expression product, and performing semantic mapping, may additionally or alternatively be applied to other analysis variations and are not limited to use with this particular analysis process.

As shown in FIG. 13, this variation may be applied within a method that includes extracting the communication metrics S120 and performing any preprocessing of the communication metrics S131, identifying base sentiment expressions (S132), (optionally) performing sentiment expression post processing (S132), and building a sentiment perception vector (S132), segmenting the transcript and an interaction artifact (e.g., a presentation) (S133), and then mapping the sentiment perception vector to the transcript and interaction artifact fragments and outputting a sentiment perception heat map (S134).

Block S131, which includes preprocessing the communication metrics, functions to condition the extracted communication metrics for analysis. Preprocessing of the communication metrics may be an optional step and not used in some instances or variations. In one preferred variation, preprocessing the communication metrics can include normalizing the communication metrics S132. Preprocessing may additionally or alternatively include calibrating communication metrics according to a baseline calculated from a captured metric (e.g., a median value of a communication metric). As a related variation, preprocessing may additionally or alternatively include adjusting or calibrating communication metrics This normalizes the communication metrics according to a particular context (e.g., based on participant background: cultural background, age, role, etc.). In some instances, the preprocessing operations such as normalization processes may be incorporated into the sentiment identification process. For example, a machine learning model may automatically normalize resulting sentiment analysis.

Block S132, which includes normalizing the communication metrics, functions to calibrate the communication metrics for different conditions. Normalizing of communication metrics can use data normalization processes applied to the communication metrics. Similar normalization processes may , which may additionally or alternatively be applied to other data representations within the method. In particular, the data normalization processes may be applied to sentiment expression related data such as base sentiment expressions and/or the sentiment perception product.

Normalizing of communication metrics may be performed based on a baseline for communication metrics, where the communication metrics (of a selected type of communication metrics can be normalized according to a baseline for the selected type of communication metrics. For example, normalizing the communication metrics may include normalizing facial feature communication metrics by normalizing a participants facial features using their default facial features as the baseline.

In some variations, where the method may be implemented prior to the actual interaction, analyzing the communication metrics S130 may include determining a baseline of at least one type of communication metric for interaction analysis. The baseline may be used to normalize interpretation of perception and/or sentiment based on the communication style of an individual. For example, some people may naturally smile more than others and so the intensity of a smile at any point may be assessed based on how it compares to a baseline facial expression. A baseline of a type of communication metric establishes the normal or “neutral” pattern of a communication metric, which may be used as a point of comparison for normalizing. Similarly, the bounds of a type of communication metric may similarly be detected, where different extreme thresholds of communication metrics along some dimension can be determined and similarly used for normalizing.

Baseline patterns may be established across all users of the method, individual users, and/or groups of users. In some cases, baselines may be established to enable “translation” of communication perception based on cultural, professional, location, demographic, and/or other filters corresponding to participants involved in an interaction. A baseline for one or more type of communication metric can be a determination of a normal state of the particular communication metric (e.g., for a particular user, a class of users, or general user). A baseline may function to enable better measurement of communication metric changes with reference to the baseline and comparison of communication metrics across participants and interactions.

Determining a baseline may include averaging historical records of interactions cues of a particular type. This may be a historical record of all past communication metrics of a particular type. This may alternatively be a running average over some period of time. In another variation, determining a baseline may include averaging historical records of a state of communication metrics during select periods of communication. These select periods of communication may be based on the timeline of a conversation. For example, a time window during the initial portion of a conversation may be used as a baseline. Other potential periods of time of interest for generating a baseline could be when a user is not speaking and is listening to another talk, when saying something with language content classified as having a neutral sentiment, and/or during other determined times. Accordingly, the method may include detecting a time period for detection of a baseline. In another variation, the method may include collecting media data as part of a communication metric calibration process. For example, a presenter may be asked to perform various tasks like “look at a camera”, “read out loud text with neutral content”, and/or perform other tasks. The communication metrics identified during this calibration process may then be used in setting the baseline for one or more types of communication metrics.

In some variations, the method may be operated over an extended period to learn trends in communication metrics. This may be used to establish baseline patterns in one or more types of communication metrics. Baseline patterns may be established across all users of the method, individual users, and/or groups of users. In some cases, baselines may be established for to enable “translation” of communication perception based on cultural, professional, location, demographic, and/or other filters corresponding to participants involved in an interaction. A baseline for one or more type of communication metric can be a determination of a normal state of the particular communication metric (e.g., for a particular user, a class of users, or general user).

The baseline may be calculated by averaging a historical record of past communication metrics. For example, the running average of facial feature communication metrics over the last hour of communication. Baselines may alternatively be determined through other heuristics used to identify a default state or patterns of a type of communication metric.

With inclusion of the baseline, the feedback may then include a force of expression based on a comparison between a first type communication metric (e.g., facial feature metrics, body pose features, gaze direction, health metrics, voice metrics, and the like) and the baseline for the first type of communication metric. For example, for a mouth related facial feature metric, the baseline for a participant may be determined to be an average smile. Future may include the force of expression with respect to the average smile, such that the participant may have a bit smile or a small smile in comparison to their average smile. In some variations extracting communication metrics S120 and analyzing the communication metrics S130 may occur regularly over desired time periods for participants (e.g., as part of a training application wherein a participant volunteers to have their behavior monitored). Machine learning and/or other data processing techniques may be applied during the monitoring to help determine a baseline.

Additionally, a baseline may be created or improved upon by incorporating social, political, regional, economic religious, and other known backgrounds for the participants. For example, facial feature communication metrics may be calibrated and normalized according to the demographics of a participant.

Normalizing of communication metrics can be applied by adjusting the communication metric by an offset based on the baseline of the type of communication metric (e.g., the median level of the metric). Additionally or alternatively, multiple “dimensions” of a communication metric may be normalized. For example, multiple classes of facial expressions may be normalized so that each one can be calibrated for a particular participant.

In one implementation, normalizing may include collecting personal data of a participant, assigning a communication metric normalization model, and applying the communication metric normalizing model to communication metrics associated with the participant. For example, an instance of the method may involve collecting external personal data such as social media and professional profile data, location data, demographic data, and/or other personal data of a participant. Then the method can use the collected personal data to determine or select one or more normalizing models based on the external personal data which may indicate cultural norms, professional/industry norms, age, location, position, and/or other factors that may impact how the participant would communication. Then the method can include applying the normalization model to communication metrics (and/or alternatively to sentiment expressions). For example, this normalizing approach may be used to normalizing and interpret facial expressions of participant from one cultural background differently from a participant from a different cultural background. Normalized (or otherwise preprocessed) communication metrics are preferably used in perform assessment and further analysis.

In one preferred implementation, analyzing communication metrics includes building a sentiment perception product based on a combination of preprocessed communication metrics S133, which functions to establish a data model for cross metric analysis. The sentiment perception product can be a time-based data derivative of sentiment expressions based at least in part on a combination of the communication metrics. The sentiment perception product may be used for detection and modeling of various forms of communication cohesion. Block S133 can work towards building a holistic omni-channel sentiment perception product that is based on the combination of extracted (and preprocessed) communication metrics. Here, omni-channel conveys use of multiple and distinct communication metric types. In general the omni-channel sentiment perception product can be based on a verbal communication metric and/or a non-verbal communication metric. As shown in FIGS. 6-10 and further described herein, various data modeling processes may be used to generate a combined and/or generalized interpretation of sentiments that incorporates input from multiple types of communication metrics. Neural network models, statistical data analysis models, decision trees, machine learning models, and/or other processes may be used and applied to the preprocessed communication metrics.

As shown in FIG. 13, the process of building a sentiment perception product can include identifying base segment expressions from the communication metrics (preferably normalized), optionally performing post processing of the base sentiment expressions, and then building the sentiment perception product from the base sentiment expressions (which may be post-processed).

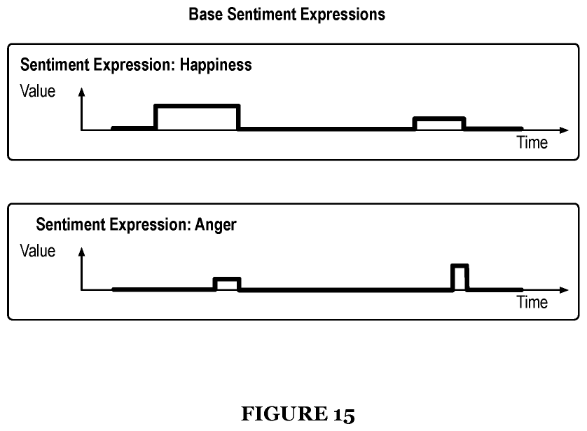

Identifying base segment expressions may use machine learning, neural networks, decision trees and/or other techniques to classify sentiments from communication metrics. Sentiments may additionally be identified at least in part from other interaction related content such as transcripts and interaction artifacts. In some variations, all or multiple communication metrics and other interaction related content are used as input into a machine learning model (or other sentiment classifier/identifier process). In other variations, all or some communication metrics and/or other interaction related content may be individually converted into base sentiment expressions (using a sentiment classifier/identifier process, which may be customized to that particular type of input.) In the base sentiment expressions, different sentiment expressions may be detected at the same time as shown in FIG. 15. Depending on the analysis method detected sentiment expressions may be assigned a value (e.g., intensity or magnitude). This value in one variation might be expressed as a “normalized strength” of an observed expression. As an additional variation, the value might correspond to the expression's probability.

Performing post processing of the base sentiment expressions may be used to condition the base sentiment expressions in preparation for building the sentiment perception product. In some variations, an initial set of base sentiment expressions may be normalized, adjusted or calibrated for an individual, a group, and/or other context (e.g., participant cultural background). Accordingly, processing of base sentiment expressions may include normalizing the sentiment expressions, calibrating sentiment expressions according to a baseline calculated from a captured sentiment metrics (e.g., a median value of a sentiment expression), and/adjusting or calibrating sentiment metrics to a particular context (e.g., based on participant background: cultural background, age, role, etc.). Normalization processes discussed above with regard to communication metrics may be similarly be adapted and used for sentiment expression related data.

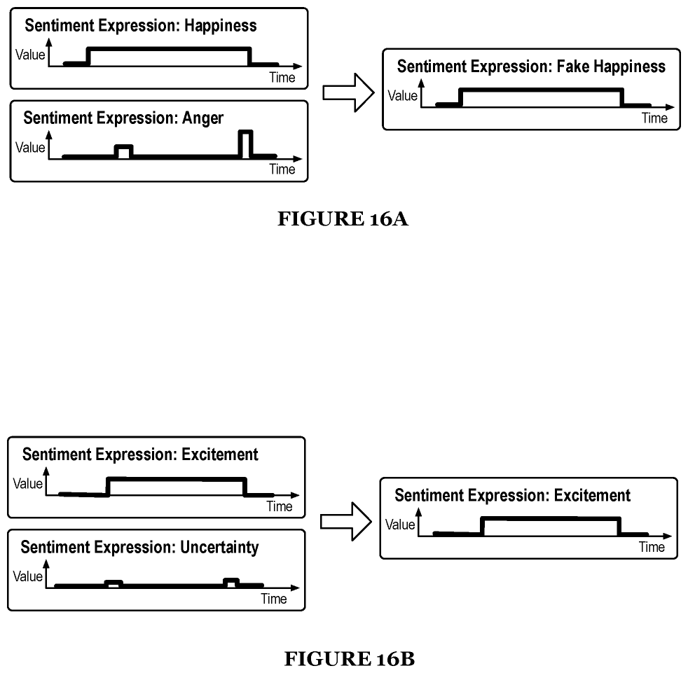

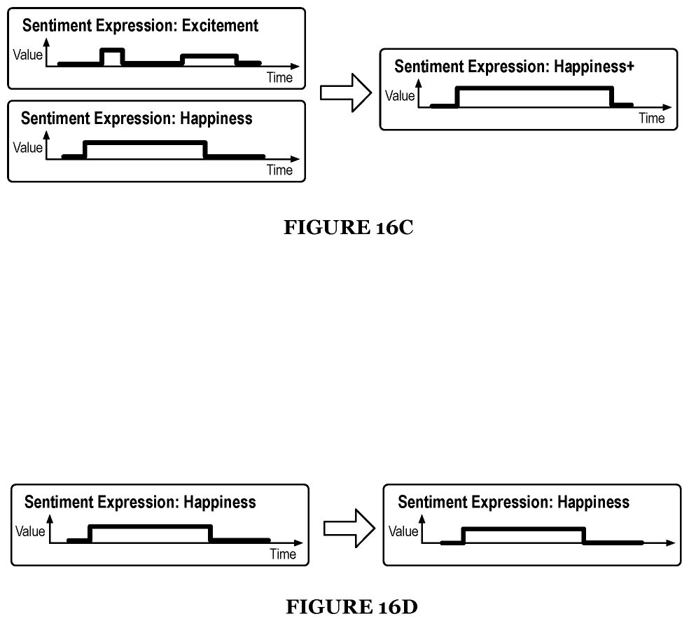

Building the sentiment perception product from the base sentiment expressions, functions to aggregate and consolidate the base sentiment expressions into a holistic representation: the sentiment perception product. This process preferably resolves discrepancies and interprets the collective occurrence of different sentiment expressions during the interaction. In one preferred variation, the sentiment perception product is a sentiment perception vector, wherein the base sentiment expressions are aggregated so as to have a single sentiment expression at a time per subject participant. This may be done by reconciling conflicting sentiments and deducing a derived sentiment as shown in FIG. 16A, filtering out sentiments as shown in FIG. 16B, combining resonating sentiments as shown in FIG. 16C, and propagating singular sentiment expressions as shown in FIG. 16D. As a result a singular sentiment perception vector, such as shown in FIG. 4, may be produced.

In some variations, the sentiment perception product may be used in providing the feedback in S140. In other variations the sentiment perception product can be used as an intermediary result used in additional analysis such as when sentiment mapping is performed for interaction fragments.

Block S134, which includes segmenting the interaction into interaction fragments according to content relevant signals, functions to establish logical divisions in the interaction based on key events or conditions conveyed within the communication metrics. Here, segmenting the interaction may mean establishing timestamp based windows or points within the timeline of the interaction. In some cases, this may be directly related of the timeline of one or more media files (e.g., the timeline of a video file). The content relevant signals are preferably directed at least in part by one or more communication metrics (e.g., the transcript, related data files like presentations).

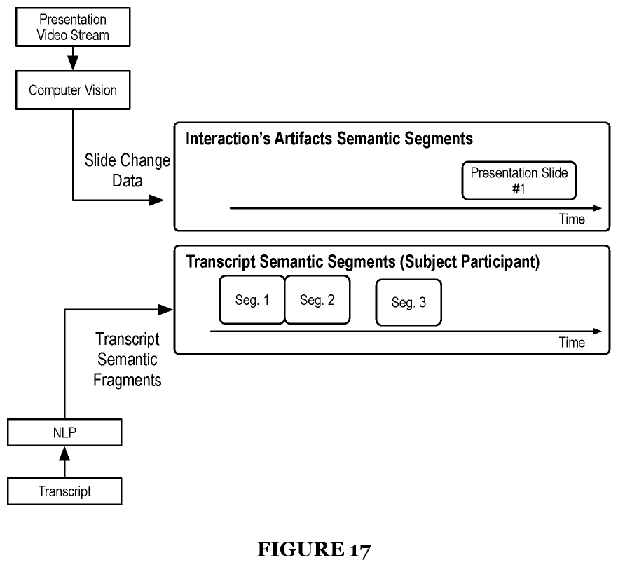

This process can include detecting fragments of semantic cohesion. In one instance, detecting a fragment with semantic cohesion can include detecting semantic cohesion of a transcript communication metric. High semantic cohesion can be a condition indicating transcript fragments with high grammar and/or lexical cohesion. In another instance, detecting fragments of semantic cohesion may include detecting fragments of audio and/or visual data separated by breaks in communication. For example, a conversation may be fragmented (at least in part) by dividing the audio based on detected windows of silence of some duration or satisfying some condition. In a related instance, detecting fragments may be based on metadata of a media stream service, and in particular detecting changes in active speakers and/or changes in video. In another example, detecting a fragment may be based on state of contextual data such as detected slide status (slide changes) of a slide presentation. The interaction fragments may include fragments from one or more different source media data or derived content from the interaction (e.g., a transcript). For example, sentiment expressions could be mapped to transcript fragments, audio fragments, video fragments, presentation fragments (e.g., slides), and other suitable portions of media/content from the interaction. As shown in FIG. 17, a transcript and presentation slides may both be segmented into fragments.

In another variation, analyzing communication metrics can include identifying interaction fragments of the interaction with high semantic cohesion S134, which functions to detect and locate specific portions of an interaction (e.g., selections of media content from an interaction) that are indicated to be of significant value based on analysis/comparison of the communication metrics. This variation may address only segmenting significant portions of an interaction (e.g., based on the sentiment perception product.) Portions of the interaction with low significance based on the sentiment perception product may or may not be segmented into interaction fragments, depending on implementation.

Block S135, which includes mapping sentiment expressions from the sentiment perception product to associated interaction fragments, functions to reflect the sentiment characterization of semantically meaningful time ranges and/or portions of an interaction. In this way, sentiment/expression-based characterization of communication is not necessarily reflected as a direct relationship to the time period directly related to that characterization, but can be mapped to the semantically meaningful time period, as achieved by the unique and specialized process described herein.

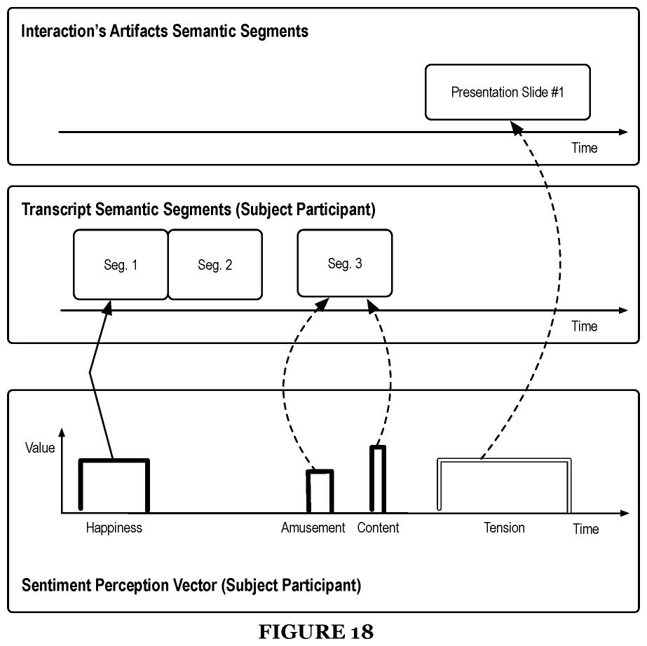

As shown in FIG. 18, real life expressions of a participant may not always synchronize with the segmented interaction fragments. Mapping can be based on the establishing of semantically meaningful fragments corresponding to the observed expressions. For example, a video may have a portion segmented as an interaction fragment because of that portion corresponds to presentation of one presentation slide. The occurrence of a significant characterization of sentiment (e.g., positive discussion during presentation of one slide), while only occurring during a sub-portion of this portion, can be mapped to the whole interaction fragment of this slide. In some instances, sentiment characterizations may not even occur during the interaction fragment to which it is mapped. For example, positive expressions of an audience (e.g., applause) may be mapped to the directly preceding interaction fragment (e.g., the statement that resulted in the applause).

In mapping the sentiment perception product to interaction fragments, the interaction may be segmented based on semantic cohesion (as discussed above), and then the sentiment perception product can be used in assigning a characterization of sentiment (e.g., positive/negative, expression classification, etc.) to an interaction fragment. The mapping preferably includes identifying an interaction fragment to which a sentiment/expression characterization corresponds based on (at least in part) on the time properties of the sentiment/expression characterization. The sentiment expression characterizations can be mapped to one or more distinct interaction fragments. In some instances, multiple distinct sentiment expression characterizations occurring within the same interaction semantic segment may be assessed collectively and used in determining how to characterize the sentiment of that particular interaction segment. For example, in the scenario where happiness is present in a first time segment and uncertainty is expressed in a second time segment, and both of these sentiment expressions correspond to the display of a presentation slide, that slide may be assigned a sentiment expression characterization based on both of these two instances of sentiment expressions. In another variation, the more dominant (higher value and/or longer duration) sentiment expression may be used. In another variation, the higher priority sentiment expression may be selected. For example, occurrences of anger may be of higher priority for notation than uncertainty and so that presentation slide may be marked with anger if any occurrence of anger happens.

Mapping of a sentiment perception product (e.g., sentiment/expression characterizations) to semantic interaction fragments may include highlighting, marking, or otherwise augmenting time ranges of an interaction (e.g., augmenting one or more media sources of an interaction). This may be used to generate a unique representation of digital interactions. In one application of this process, video and/or audio content could have sentiment/expression based breakdown for navigating content. For example, video (possibly without a transcript) may have time-based breakdown of expressions and/or other characterizations of communication. In this way, viewers of the video could jump to the most engaging/positive portions of the video. Accordingly, the method may include within a video/audio player setting time-based bookmark at semantic interaction fragments and annotating bookmarks with indicators of the mapped sentiment/expression characterization. In this way, the video player can be transformed so as to allow navigation and/or presentation of the media content based on this mapping.

In one variation, a sentiment perception heat map of the interaction (segmented by relevant contextual/semantic interaction fragments) could be generated and used as a report on the interaction, used as feedback for one or multiple participants, used in driving a digital interaction, used as a data source for driving other digital operations, and/or used in any suitable manner.

Block S140, which includes providing communication analysis results, functions to leverage interpretation of communication perception in assessing the interaction. In some variations, this analysis result can be used in reporting and automatically breaking down interaction. As another variation, providing communication analysis can include providing feedback analysis. Providing communication analysis results S140 may occur in real-time, concurrent to the participant interaction, wherein a participant (preferably the subject participant) may receive real-time signals communicating the analysis results. This may involve updating a visual user interface to represent updated state of analysis results. Additionally or alternatively, providing communication analysis results S140 may occur after the interaction. The timing of providing communication analysis S140 may be implementation specific.

In some variations, providing a feedback analysis provides at least a real-time feedback. Real-time feedback may function as a subject participant guidance tool (e.g. as a smartphone application) aiding the subject participant in gauging target participants. For example, as a phone application, providing a feedback analysis S140 may comprise of a specific type of vibration mode (e.g. single vibration) to signal positive interaction by the subject participant, and a different type of vibration mode (e.g. double vibration) to signal a negative interaction by the subject participant. In some implementations, the intensity of the signal may increase or decrease to denote how positive or negative the last interaction by the subject participant was. This type of real-time feedback may be additionally or alternatively implemented on a computer, or any other type of computationally processing device. In another real-time example, the method may be incorporated with smart glasses. In this example, providing feedback S130 may provide the subject participant real-time visual details (on the glasses) regarding an ongoing interaction. In one real-time feedback, smart glasses may provide visual images that correspond to interaction highlights, e.g., positive fragments of conversation, neutral fragments of conversation, and negative fragments of the conversation. In a color-based implementation, a green light may demonstrate a positive feedback, a gray light neutral feedback, and a red light negative feedback.

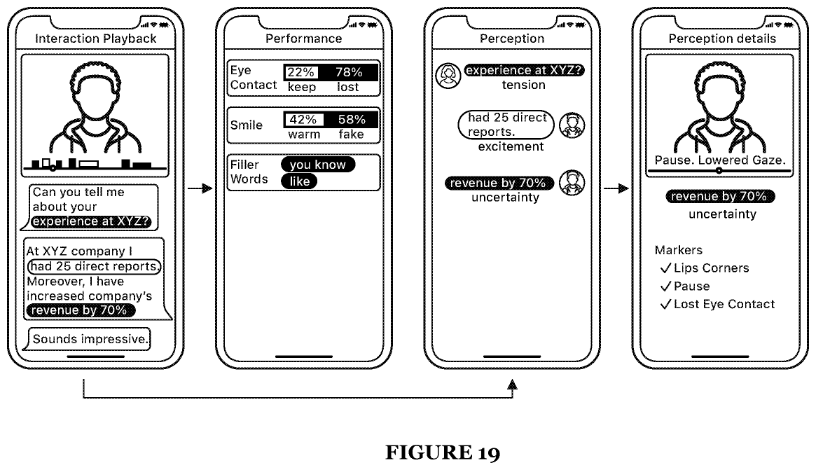

In some variations, providing a feedback analysis S140 provides a report analysis, preferably after the interaction or after part of the social interaction. In these variations, providing a feedback analysis S140 may function to provide a more in-depth feedback analysis. The personalized feedback analysis preferably includes a report that may highlight both effective and ineffective external cues of the subject participant. As a tool for sales, the report may provide interaction insights. The report preferably includes a perception report, i.e. how target participants perceived, or may have perceived the social interaction. The report may include a breakdown of the subject participant's interactions with each target participant, the subject participant's effectiveness with all participants, the strengths and weakness of the subject participant, and a timeline of the social interaction such as in the exemplary representations of user interfaces of FIG. 19. The report may include any other desired information regarding the social interaction, and preferably may be customized for a user participant and/or for a type of interaction.

In some variations, providing a feedback analysis S140 includes providing an expression mapping (or expression map) such as a sentiment perception heat map. The expression mapping functions to provide a time series analysis of the interaction. In some variations, the expression mapping can be a sentiment perception heat map such as described above, but may alternatively comprise a different type of mapping. A sentiment perception heat map may use visual color mapping with respect to sentiment/expression characterizations. Examples of other types of heatmap mappings include: haptic mapping (e.g. provides vibrational feedback in real-time), graph mapping, and aural mapping (e.g. providing sound signals to the user, possibly through an earpiece, in real-time). As discussed, a sentiment perception heatmap may map participant expressions to fragments of language content. In one implementation, the heatmap shows the participant(s) sentiment with respect to the language content, thereby providing a heatmap of the participant(s) perceived sentiment level over time. In another implementation, a heatmap shows the participant expression with respect to the language content, thereby providing a heatmap of the participant sentiment over time. Expression heat maps may be provided as part of the report and/or real-time feedback. As part of the report, the expression heatmap may provide a full timeline heatmap.

This implementation may be particularly useful in indirect, or media-facilitated interactions (e.g. phone conversation, over computer communication, camera “observed” interaction). This implementation may be particularly useful in one-on-one interactions (e.g. customer interactions over computer or phone), but may be equally implemented during larger interactions (e.g. speech given to a camera monitored audience). During the social interaction, the expression feedback may provide real-time feedback of the participant(s) perception assessment, thereby enabling and guiding the subject participant to alter the course of the interaction depending on a partner participant reactions to particular topics (e.g. providing colored cues to guide the subject participant). Examples of this implementation include: interview over a desktop screen, camera monitored interaction with customer/client, camera monitored interrogation interaction, video conference, or audio conversation.

The expression mapping may also be implemented as an augmented reality application wherein the method may be incorporated into a preferably portable and wearable system (e.g. smart phone or smart glasses). In this implementation, the method may “focus” on providing real-time expression feedback to the subject participant during the social interaction. In the expression heatmap variations, the augmented reality device (e.g. smart glasses) may provide real-time feedback by presenting a live expression heatmap during the social interaction (e.g. conversation).

Expression mapping may also be implemented for medical use cases. For example, expression haptic mapping may be used to aid a visually impaired subject participant. Vibrational feedback may aid the subject participant in assessing correctly visual external cues of target participants that the visually impaired participant would not be able to observe. For a hearing-impaired subject participant example, the hearing-impaired user may be able to understand a conversation (e.g. possibly through text transcription or reading lips) but fail to hear verbal cues (e.g. sarcastic tone or pace of the speech). Expression heatmapping may then provide visual cues to aid the subject participant in better contextualizing the social interaction. For example, this may be useful who are less social conciseness (e.g. lower nonverbal sensitivity) or have Empathy Deficit Disorder (EDD).

In some variations, providing a feedback analysis includes providing recommendations for the subject participant. These recommendations function to help potentially improve the effectiveness of the subject participant. For a real-time implementation, recommendations may comprise signals to remind the subject participant to alter their behavior (e.g. a small to buzz to remember to smile, a maintained vibration to signal to the subject participant to speak faster). As a report analysis, recommendations may include explanations of when and how the subject participant should act (or should have acted). In this manner report analysis of the subject participant may provide recommendations to address scenarios with areas for improving sentiment of one or more participant. Recommendations may include content and/or behavioral recommendations. Content recommendations comprise recommendations regarding speech content (e.g. to not using a specific word or discussing certain topics, pronunciation corrections). Behavioral recommendations comprise physical gestures, such as smiling, speaking louder, enunciating better, standing up straight, lower voice pitch, slow speech pace, add pauses to speech, topics of discussion, usage of multimedia, etc. For example, it may be determined that a customer becomes upset when a certain topic is discussed with a customer service agent; a recommendation can be presented to avoid or change the topic.

In one implementation, providing a feedback analysis is applied to updating the state of an automated simulated interview. In an implementation where the method is applied to a simulated interview application, a list of interview questions or prompts may be delivered to a user. These prompts may be pre-defined. The selection of these prompts may be dynamically selected based on the communication feedback for responses to one or more prompts. Dynamic selection of prompts based on the feedback analysis may be used to focus on which types of prompts should be incorporated to better facilitate the practice of responding to prompts that cause more problems. For example, a prompt that results in a subject participant responding with various contradictions (or communication issues) may result in a similar type of prompt to be delivered; wherein if the prompt is detected to have a participant response without any problems, then less practice in that area may be needed and so different prompts may be selected. In one variation, prompts may be dynamically generated from a data source associated from the participant. For example, a professional profile of a participant (e.g., a digital resume, social media profile, job application) may be used in generating questions. Prompts may be generated from this data source based on the feedback analysis of one or more responses.

The method may be applied in the analysis and/or augmenting of an interaction and its associated digital media content. Exemplary use cases described below include: use of the method for video conferencing, use of the method for guided interactions, use of the method during live real-life communication, and use of the method for used in alternative computing environments such as AR/VR computing environments.

In one exemplary use case, the method may be used as a digital tool within a conferencing service. Conferencing service may include audio, video, screensharing, and/or other forms of conferencing services enabling one or more participants to communicate through a communication medium. In such use cases, collecting media data during the interaction comprises collecting media data from a video conferencing service connecting at least two participants.

The method may be used within a conferencing service for tracking and building a sentiment perception heat map of interaction fragments and/or time ranges. In one example, this heat map based expression mapping may be used by one or more participants. Depending on the scenario and/or implementation, the heat map can reflect different forms of sentiment perception such as how a subject participant is receiving communication from another participant, how a subject participant is outwardly communicating content to other participants, and/or how target participants are receiving content from a subject participant. For example, the digital tool may be used by primary participant (e.g., a sales agent) to get real-time feedback or a report on how his or her sentiments were reflected in the fragments of another participant's speech. In another example, the digital tool may be used by the primary participant to see how their sentiments are reflected in their fragments of speech.

The digital tool may present and update the analysis report in real-time. For example, a participant may be presented with an analysis report on a computing device (e.g., a mobile device, a desktop computer, an audio device, and/or an AR/VR headset). The analysis report may be presented privately (e.g., only seen by a select set of participants) or publicly (e.g., shared with all participants). In an AR/VR headset, analysis report may be presented within a heads-up display (HUD). The analysis report presented could include the interaction transcript, a heatmap, and/or other form of analysis report generated through the processes described herein.

The digital tool may alternatively present and/or generate an analysis report as a report post-interaction. This may be presented as a summary of an interaction. This may alternatively be added as data to a cumulative record of interactions, which may be used and processed by an analytics system to provide high level insights into patterns across different interaction sessions.

A real-time analysis report and/or a post-interaction report may be further processed (e.g., using a machine learning based analyzer) to evaluate, rate, and/or provide recommendations for future interactions or other forms of guidance based on the analysis report.

In another exemplary use case, the interaction can be a part of a guided interaction within a computer implemented application or service. In some cases, the method may be used in the control and execution of guided digital interactions within one or more computing devices. A guided digital interaction may monitor interactions of one or more participants during a digital interaction. In one exemplary application, the method may be used for digital interactions involving prompting and responding via video, audio, and/or text chat. Sentiment-based analysis can be performed through the method in some variations generating a prompt within a user interface of an application and collecting media data at least during a response to the prompt by at least one participant. In one exemplary implementations, the guided interaction application may be a social application (e.g., a dating application) facilitating communication between at least two participants. In another implementation the guided interaction application may be a training application with a single participant responding to generated prompts. In one variation, the analysis report may be used in altering or augmenting the digital interactions. For example, an interview simulation may alter selection and presentation of prompts/questions according to the analysis report and/or a sentiment perception product resulting from a response to an earlier prompt/question. In another example, the analysis report (e.g., a sentiment perception heat map) may be presented as feedback for a participant answering questions so that they can see how their sentiment response is perceived.

In one exemplary instance of an implementation, a participant can receive a question or prompt. The prompt may be generated by the system using a set of pre-configured prompts. The prompt may alternatively be automatically generated or selected dynamically. The participant then supplies a response to the prompt (e.g., recording an audio/video response or submitting a text response). After and/or during submitting the response, a sentiment perception heat map of other participants during the answering may be presented to the participant.

In another exemplary instance of an implementation, another participant receives a prompt and responses. Then the participant is provided with a sentiment perception heat map of other participants.

As discussed, one exemplary guided interaction application can include a social trainer implementation/application. A trainer application may vary dependent on implementation. Examples of trainer applications may include: a communication coach (e.g., for a practice interview, dating coach), presentation trainer (e.g., for giving speeches), enterprise level coach (e.g., sales agent trainer, customer service trainer, teacher), and the like. As desired, the trainer application may be applied for a specific or general implementation. For example, a highly specialized presentation trainer may be implemented for elevator talks. For trainer application implementations, the method may further include creating and/or generating faux target participant(s) (i.e., faux targets) that interact with the subject participant.

In one implementation of a trainer application, faux targets may interact with the subject participant through the implemented application (e.g., a trainer smartphone application or a trainer generated video conversation) but may interact with the subject participant through any other desired means (e.g., a machine-controlled phone service, a virtual environment, etc.). Faux targets may interact through gestures (e.g., facial gestures) and/or verbal communication. Dependent on implementation, faux targets may initiate interaction (e.g., ask questions), respond to the subject participant (e.g. show interest and/or disinterest through facial expressions on a conference call), or a combination of both initiation and response. For example, as part of an interview trainer application, a faux target may initiate a conversation by asking a subject participant specific questions and project simulated sentiment expressions (e.g., forming different facial expressions of a particular sentiment) as a reaction to a subject participant's response.

In another exemplary use case, the method may be used during live in-person communications. In this use case, the analysis report and/or the sentiment perception product may be used in generating user interface updates based on in-person communications. This is preferably used when life video capturing is used. Accordingly, in such a use case, collecting media data during the interaction can include capturing media data from a worn computing device, wherein the captured media data includes video data of a person interacting with a wearer of the computing device. This use case may involve the use of media data captured using a mobile device, an AR/VR device, and/or an alternative video/audio/spatial capturing device. For example, the worn computing device above could be AR headset device or other suitable worn computing device. In this use case, a person may receive reporting based on a sentiment perception heat map (or other type of analysis results) that is built with data from a capturing device. For example, a user wearing AR smart glasses may receive live reporting when talking to another person. In another example, a person presenting a presentation may receive a heat map for audience reactions and sentiments based on data collected from a video capture device directed at the audience.

In some variations, the method may include exposing a programmatic interface to the analysis report of an interaction. Exposing a programmatic interface to the analysis report may include exposing an application programming interface (API) to data associated with the analysis report. The programmatic interface may additionally be used for controlling or managing the execution of the method. For example, an API request may direct a computing platform to process select communication media and generate a sentiment perception heat map and then access that sentiment perception heat map for some use outside of the computing platform. In this way, the method may be offered as a PaaS.

In other variations, the method may be operated and used internally as part of a communication service platform (e.g., video conferencing service), a media hosting service (e.g., a video hosting site), and/or as part of the digital services. In such a variation, the method may include operating a media related application and using the analysis results within presentation of the media in a user interface. For example, a video hosting site may implement the method described herein and present the analysis results as part of the presentation of the video (e.g., embedded within the video player). Similarly, more targeted apps such as an application using the method for directed interactions may similarly implement the method directly.

### 3. System

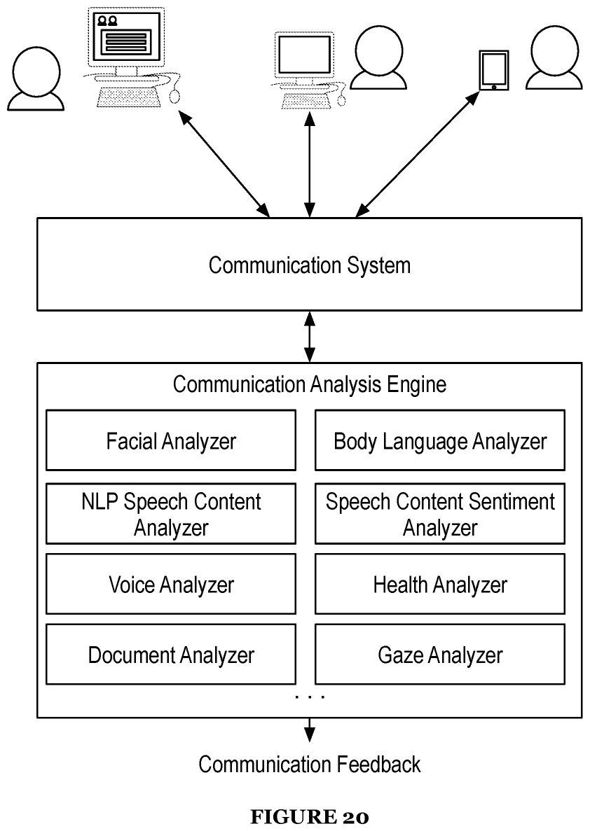

As shown in FIG. 20, a system for interaction analysis can include a media analysis engine comprised of multiple analysis process modules that are configured to perform processes of the method for analysis and to generate communication feedback. The media analysis engine is preferably implemented in connection with a digital media system configured to collect different types of communication media. The media analysis engine may additionally be integrated directly into the digital media system.

The digital media system functions as the system components to capture media for analysis. The digital media system can include a visual recording device, an audio recording device, a spatial capturing device, and/or other capture or sensing devices wherein visual elements, audio elements, spatial elements or other interaction related data of an interaction may be captured and digitized for analysis. The digital media system is directly, or indirectly, connected to the media analysis engine. In some variations, the digital media system is the primary source of media collection. The digital media system may additionally include media files and/or interfaces to other communication channels that may provide interaction related data.

Alternatively, external sources may be used for media capture. This may be particularly the case for non-visual/non-audio data (e.g., 3^{rd} party social media, etc.). In these variations, external data sources may be incorporated to provide the media analysis engine with media data and/or other suitable interaction related data (such as static files used during an interaction). In some preferred variations, both the digital media system and external data sources are incorporated to capture and/or access media data. External data sources may additionally include contextual data modules. Contextual data modules may provide “background” information that may be useful for an interaction analysis. Background information may include: time of day, date, outside temperature, interaction location, etc.

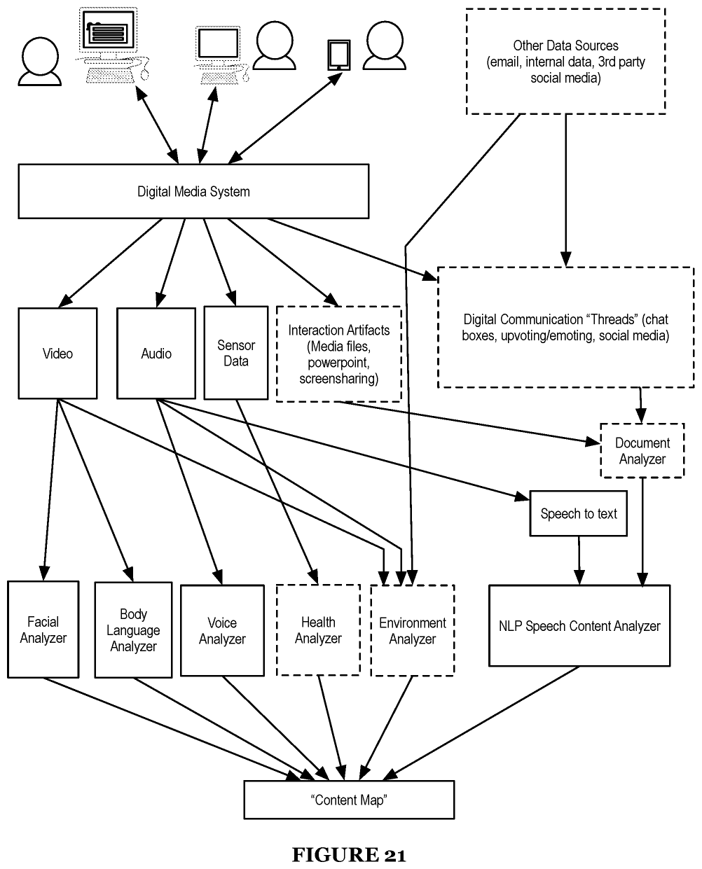

The media analysis engine and/or the various analysis modules (e.g., a facial analyzer, body language analyzer, sensor system, NLP speech analyzer) comprise of at least one processor (i.e., media analysis system) including machine-readable instructions configured such that when executed cause the processor to perform the processes described herein. In one sample implementation, as shown in FIG. 21, the media analysis engine comprises a facial analyzer, body language analyzer, a sensor system, environment analyzer, an NLP speech analyzer, a voice analyzer, a health analyzer, and/or any suitable analyzer module configured for an analysis process described herein.

The facial analyzer may include components to identify and track facial features in a video, and may be configured to track and analyze user facial metrics.

The body language analyzer, may include components to identify human participants and track body motion in a video, and maybe configured to track and analyze body gesture metrics.

The sensor system may comprise a set of desired sensor modules used to measure and track participant “vital” signs. Examples of sensor system modules include a heart rate monitor, breathing monitor, sweat sensor, temperature sensor, etc.

The environment analyzer may include components to identify the general background environment (through video, audio, and/or spatial data) and track the background environment. Additionally, in some variations, the environment analyzer may connect to other data sources and acquire additional contextual background information as required. Background environment details may include: interaction location, time, temperature, weather, setting details (e.g., public, private, crowded, loud, quite), etc.

The NLP speech analyzer may include components for speech analysis. the NLP speech analyzer may incorporate circuitry for analysis of different types of speech (e.g., spoken or written language). This may include a speech to text module and/or a document analyzer. The speech content analyzer may additionally include components for analysis of speech sentiment (e.g., sarcasm).

The system may additionally include an application system, which functions to offer client applications to various users. The application system preferably includes at least a client application with which users will interact. The application system may additionally include a remote server system used to facilitate interactions with a client application. In one example, the system may include trainer application used by a user. In another example, the system may include a communication tool application, which facilitates communication of two or more users and offers integrated communication analysis reporting as described herein within the user interface of the application.

In some variations, the system may include an application plug-in, which functions to enable application-level functionality within another application. For example, the system may include a communication tool plug-in, which can enable communication feedback provided by the system to be offered within another communication tool.

### 4. System Architecture

The system may be comprised of any Turing complete device, preferably including a processor, and further including optionally a visual recording device, an audio recording device, a spatial capturing device, and/or other capture or sensing devices. In some variations, the system may comprise only video recording or audio recording with a processor. The system functions to provide monitoring and analysis tools for a social interaction.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

In one variation, a system comprising of one or more computer-readable mediums storing instructions that, when executed by the one or more computer processors, cause a computing platform to perform operations comprising those of the system or method described herein such as: collecting communication media data; analyzing external cues; and providing a feedback analysis.

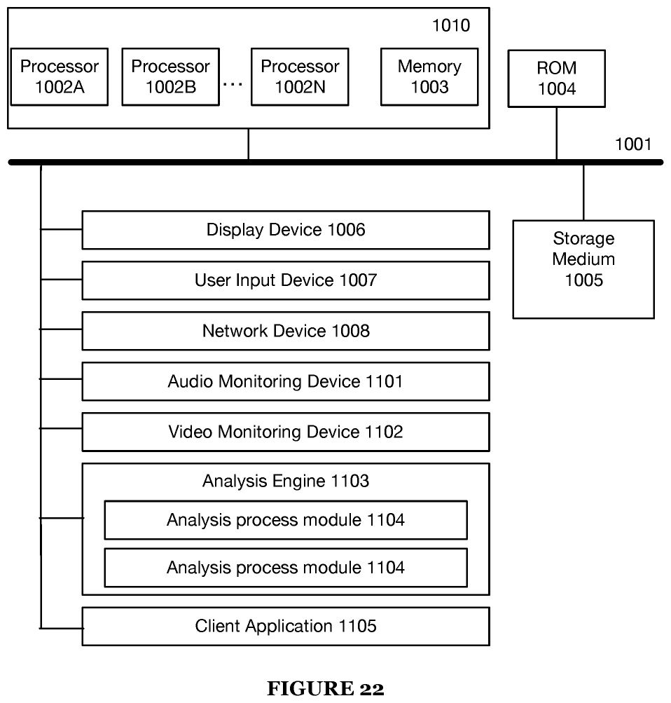

FIG. 22 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1202N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting audio monitoring device 1101, a video monitoring device, 1102, an analysis engine 1103 with one or more analysis process modules 1104, a client application 1105, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1201A-1201N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1205 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1205 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
at a digital media system, collecting media data of an interaction;
at a media analysis engine, extracting communication metrics from the media data;
analyzing the communication metrics and generating a sentiment perception product that is a time-based data derivative of sentiment expressions based at least in part on a combination of the communication metrics; and
providing communication analysis results that are based at least in part on the sentiment perception product.

2. The method of claim 1, wherein the sentiment perception product is used in mapping sentiment expressions to select segments of the interaction.

3. The method of claim 2, wherein analyzing the communication metrics comprises generating a sentiment perception heat map based on the sentiment expressions mapped to segments of the interaction.

4. The method of claim 3, wherein providing communication analysis results comprises presenting the semantic perception heat map in a user interface during the interaction.

5. The method of claim 3, wherein providing communication analysis results comprises presenting the semantic perception heat map after conclusion of the interaction.

6. The method of claim 1, wherein analyzing the communication metrics further comprises:
normalizing the communication metrics;
building the sentiment perception product based on a combination of the normalized communication metrics;
segmenting the interaction into interaction fragments according to content relevant signals; and
mapping sentiment expressions from sentiment perception product to associated interaction fragments.

7. The method of claim 6, further comprising determining a baseline of a first type of communication metric of a first participant in the interaction; and wherein normalizing the communication metrics comprises, for the first participant, adjusting the first type of communication metric by an offset based on the baseline.

8. The method of claim 6, wherein segmenting the interaction into interaction fragments according to content relevant signals comprises segmenting the interaction into interaction fragments according to semantic cohesion of a transcript, a screen capture, or presentation materials.

9. The method of claim 6, further comprising collecting social and cultural background data of a participant determining a normalizing model based on the social and cultural background data, and applying the normalizing model to the communication metrics of the participant.

10. The method of claim 1, wherein the interaction is part of a guided interaction within an application; and further comprising generating a prompt and collecting media data at least during a response to the prompt by at least one participant.

11. The method of claim 10, wherein the application is a social application facilitating communication between at least two participants.

12. The method of claim 10, wherein the application is a training application with a single participant responding to generated prompts.

13. The method of claim 12, further comprising generating at least a second prompt based on the communication analysis results of the response to the prompt.

14. The method of claim 1, wherein collecting media data during the interaction comprises collecting media data from a video conferencing service connecting at least two participants.

15. The method of claim 1, wherein collecting media data during the interaction comprises capturing media data from a static, mobile, or worn computing device, wherein the captured media data includes video data, audio data, or spatial data of a person observed by the computing device.

16. The method of claim 15, wherein the computing device is an augmented reality headset device that captures media data of a person interacting with a wearer of the computing device.

17. The method of claim 1, further comprising exposing a programmatic interface to the analysis report may include exposing an application programming interface (API) to data associated with the analysis report.

18. The method of claim 1, further comprising operating a media related application and using the analysis results within presentation of the media in a user interface.

19. A non-transitory computer-readable medium storing instructions that, when executed by one or more computer processors of a computing platform, cause the computing platform to perform the operations comprising:
collecting media data of an interaction;
extracting communication metrics from the media data;
analyzing the communication metrics and generating a sentiment perception product that is a time-based data derivative of sentiment expressions based at least in part on a combination of the communication metrics; and
providing communication analysis results that is based at least in part on the sentiment perception product.

20. A system comprising of:
one or more computer-readable mediums storing instructions that, when executed by the one or more computer processors, cause a computing platform to perform operations comprising:
collecting media data of an interaction;
extracting communication metrics from the media data;
analyzing the communication metrics and generating a sentiment perception product that is a time-based data derivative of sentiment expressions based at least in part on a combination of the communication metrics; and
providing communication analysis results that is based at least in part on the sentiment perception product.
